(19) United States
(12) Patent Application Publication
(10) Pub. No.: US 2004/0041987 A1
(43) Pub. Date: Mar. 4, 2004

(54) Projection system

(75) Inventors: Eun Seong Seo, Seoul (KR); Young Woon Kim, Suwon-si (KR)

Correspondence Address: JONATHAN Y. KANG, ESQ., LEE, HONG, DEGERMAN, KANG & SCHMADEKA, 14th Floor, 801 S. Figueroa St., Los Angeles, CA, 90017, US

(73) Assignee: LG Electronics Inc.

(21) Appl. No.: 10/651,097

(22) Filed: Aug. 28, 2003

(30) Foreign Application Priority Data
Aug. 30, 2002 (KR) 51924/2002

(51) Int. Cl. G03B 21/28

(52) U.S. Cl. 353/98

(57) ABSTRACT

A projection system comprises a projection lens for enlarging and projecting an image, an optical element for reenlarging an enlarged image through the projection lens, and reflecting the image on a predetermined position, and a rear mirror for displaying an reflected image through the optical element on a screen.

### BACKGROUND OF THE INVENTION

1. Field of the Invention

The present invention relates in general to a projection system, more particularly, a projection system having a reduced thickness by applying an additional optical part, besides a projection lens, to the projection method.

2. Discussion of the Background Art

Along with the scale-up trend of TVs, more researches are needed on a projection system as well.

A typically used image element for the projection system includes a liquid crystal deposited on poly silicon and silicon crystal, or a nano-technique based DMD. Particularly, a projection system using the liquid crystal device (LCD) displays a screen by modulating the polarization of light.

FIG. 1 diagrammatically illustrates a construction of a projection system, according to the related art.

Referring to FIG. 1, the related art projection system comprises a projection lens 1 for emitting an image in the form of light, a rear mirror 2 for reflecting the emitted light from the projection lens 1, and a screen 3 for displaying the light reflected from the rear mirror 2.

Here, the rear mirror 2 is tilted at an angle of less than 90 degrees from a horizontal line. This is because the light emitted from the projection lens 1 disposed at a lower portion needs to be reflected by the rear mirror 2 and later displayed on the screen 3.

That is, to project the light emitted from the projection lens 1 on the screen, the rear mirror 2 is tilted at an angle of between 50 and 60 degrees from the horizontal line, and depending on this angle between the rear mirror 2 and the horizontal line, the thickness of the projection system is increased.

In other words, a problem with the projection system according to the related art is that the thickness of the projection system is great mainly because the tilt-angle difference between the rear mirror 2 and the screen is rather big (approximately 30-40 degrees).

The above problem gets more serious now that wide-screen TVs are developed and the rear mirrors 2 therein are also enlarged.

### SUMMARY OF THE INVENTION

An object of the invention is to solve at least the above problems and/or disadvantages and to provide at least the advantages described hereinafter.

Accordingly, one object of the present invention is to solve the foregoing problems by providing a projection system having as little thickness as possible by changing a traditional projection method.

The foregoing and other objects and advantages are realized by providing a projection system including a projection lens for enlarging and projecting an image, an optical element for reenlarging an enlarged image through the projection lens, and reflecting the image on a predetermined position, and a rear mirror for displaying an reflected image through the optical element on a screen.

In the exemplary embodiment, the optical element is either a spherical mirror or a non-spherical mirror.

In the exemplary embodiment, the optical element is disposed at an upper portion of the projection lens.

In the exemplary embodiment, the rear mirror is tilted at an angle of 90-130 degrees from a horizontal line, and more preferably, the rear mirror is tilted at an angle of 90-110 degrees from a horizontal line.

In the exemplary embodiment, a tilt-angle difference between a rear mirror and a screen ranges 0-40 degrees.

In the exemplary embodiment, the optical element is disposed at an upper portion between a rear mirror and a screen.

In the exemplary embodiment, the rear mirror is one of planar mirror, spherical mirror or non-spherical mirror.

According to another aspect of the invention, a projection system includes a projection lens for enlarging and projecting an image; an optical element formed of a non-spherical mirror, reenlarging an enlarged image through the projection lens, and reflecting the image on a predetermined position; and a rear mirror for displaying an reflected image through the optical element on a screen, the rear mirror being tilted at an angle of 90-130 degrees from a horizontal line.

Additional advantages, objects, and features of the invention will be set forth in part in the description which follows and in part will become apparent to those having ordinary skill in the art upon examination of the following or may be learned from practice of the invention. The objects and advantages of the invention may be realized and attained as particularly pointed out in the appended claims.

### BRIEF DESCRIPTION OF THE DRAWINGS

The invention will be described in detail with reference to the following drawings in which like reference numerals refer to like elements wherein:

FIG. 1 illustrates a construction of a projection system according to a related art;

FIG. 2 shows a construction of a projection system according to the present invention; and

FIG. 3 depicts one embodiment of a projection system according to the present invention.

### DETAILED DESCRIPTION OF PREFERRED EMBODIMENTS

The following detailed description will present a projection system according to a preferred embodiment of the invention in reference to the accompanying drawings.

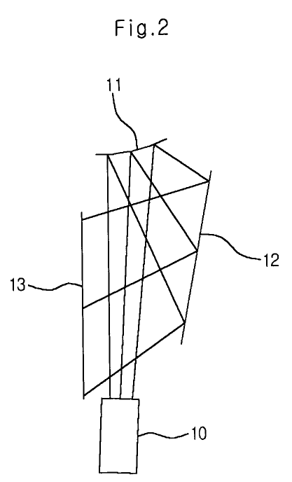

FIG. 2 is a diagram illustrating a construction of a projection system according to the present invention.

As shown in the drawing, the projection system of the present invention includes a projection lens 10 for enlarging and projecting an image, an optical element 11 for reflecting the enlarged image and reenlarging the image when reflecting, and a tear surface 12 for reflecting the enlarged image onto a screen.

In general, a spherical mirror or a non-spherical mirror is used as the optical element 11 so that an incident ray (light) is magnified and reflected on a predetermined position.

According to the above projection system, an enlarge image through the projection lens 10 is reflected by the optical element 11, namely a mirror, and the angle for light traveling is greatly increased. Later, the image is reflected by the rear mirror 12 again and incidented on the screen 13.

As for another embodiment, the rear mirror 12 can be used simply to reflect the light and make the light incidented on the screen 13. Also, using a spherical non-spherical mirror, it is possible to magnify the light when reflecting and make the light incidented on the screen 13.

Therefore, the projection system is different from the related art projection system in that a spherical or non-spherical mirror acting as the optical element 11 is disposed at an upper portion of the projection lens 10.

As such, the light being magnified through the optical element 11 is reflected by the rear mirror 12, and incidented upon the screen 13. As a result, the thickness of the projection system can be remarkably reduced.

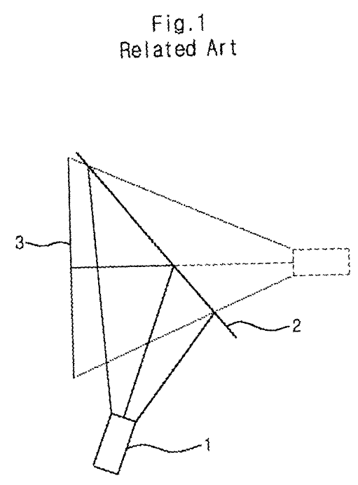

As depicted in FIG. 1, the rear mirror 12 in the related art projection system is tilted at an angle of less than 90 degrees from the horizontal line. In the projection system of the present invention, however, the optical element 11 is disposed at the upper portion of the projection system, so the rear mirror 12 is tilted at an angle of greater than 90 degrees from the horizontal line.

More specifically, because the rear mirror 12 of the projection system according to the present invention is tilted at an angle of between 90 and 130 degrees from the horizontal line, the thickness of the projection system is reduced.

Even though the screen 12 gets enlarged, the thickness of the projection system is not greatly influenced thereby.

In other words, according to the present invention, not only the projection lens 10 but also the optical element 11 is used to enlarge the image. Hence, it becomes possible to minimize a tilt-angle that the rear mirror 12 makes from a vertical line.

In this manner, the thickness of the projection system can be remarkably reduced.

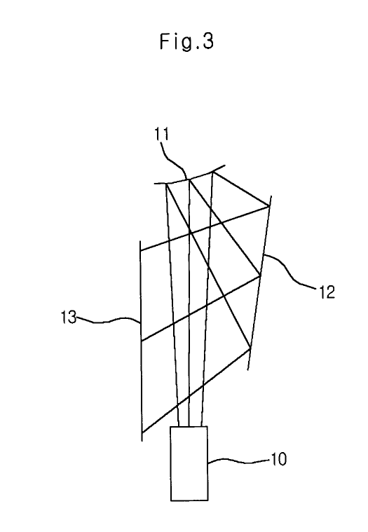

FIG. 3 shows one embodiment of the projection system according to the present invention. As shown, the projection system includes a projection lens 10, an optical element 11, a rear mirror 12, and a screen 13, and the rear mirror 22 is tilted at an angle of 90-110 degrees from the horizontal line.

In conclusion, the projection system of the present invention, mounted with the projection lens 10, the optical element 11 for magnifying and reflecting light, and the rear mirror 12, can be advantageously used for remarkably reducing the thickness of the projection system. For an embodiment of the above projection system, the thickness of a projection TV can be minimized.

While the invention has been shown and described with reference to certain preferred embodiments thereof, it will be understood by those skilled in the art that various changes in form and details may be made therein without departing from the spirit and scope of the invention as defined by the appended claims.

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art. In the claims, means-plus-function clauses are intended to cover the structures described herein as performing the recited function and not only structural equivalents but also equivalent structures.

What is claimed is:

1. A projection system comprising:
a projection lens for enlarging and projecting an image;
an optical element for reenlarging an enlarged image through the projection lens, and reflecting the image on a predetermined position; and
a rear mirror for displaying an reflected image through the optical element on a screen.

2. The projection system according to claim 1, wherein the optical element is a spherical mirror.

3. The projection system according to claim 1, wherein the optical element is a non-spherical mirror.

4. The projection system according to claim 1, wherein the optical element is disposed at an upper portion of the projection lens.

5. The projection system according to claim 1, wherein the rear mirror is tilted at an angle of 90-130 degrees from a horizontal line.

6. The projection system according to claim 1, wherein the rear mirror is tilted at an angle of 90-110 degrees from a horizontal line.

7. The projection system according to claim 1, wherein a tilt-angle difference between the rear mirror and the screen ranges 0-40 degrees.

8. The projection system according to claim 1, wherein the optical element is disposed at an upper portion between the rear mirror and the screen.

9. The projection system according to claim 1, wherein the rear mirror is a planar mirror.

10. The projection system according to claim 1, wherein the rear mirror is a spherical mirror.

11. The projection system according to claim 1, wherein the rear mirror is a non-spherical mirror.

12. A projection system comprising:
a projection lens for enlarging and projecting an image;
an optical element formed of a non-spherical mirror, reenlarging an enlarged image through the projection lens, and reflecting the image on a predetermined position; and
a rear mirror for displaying an reflected image through the optical element on a screen, the rear mirror being tilted at an angle of 90-130 degrees from a horizontal line.

13. The projection system according to claim 12, wherein the optical element is disposed at an upper portion of the projection lens.

14. The projection system according to claim 12, wherein the rear mirror is tilted at an angle of 90-110 degrees from a horizontal line.

15. The projection system according to claim 12, wherein a tilt-angle difference between the rear mirror and the screen ranges 0-40 degrees.

16. The projection system according to claim 12, wherein the optical element is disposed at an upper portion between the rear mirror and the screen.

17. The projection system according to claim 12, wherein the rear mirror is a planar mirror.

18. The projection system according to claim 12, wherein the rear mirror is a spherical mirror.

19. The projection system according to claim 12, wherein the rear mirror is a non-spherical mirror.
